(19) United States
(12) Patent Application Publication
(10) Pub. No.: US 2007/0046769 A1
(43) Pub. Date: Mar. 1, 2007

(54) Apparatus to adjust alignment between scanning lines of laser printer and method thereof

(76) Inventors: Young-jin Park, Bucheon-si (KR); Yoon-tae Lee, Yongin-si (KR)

Correspondence Address: STANZIONE & KIM, LLP, 919 18TH STREET, N.W., SUITE 440, WASHINGTON, DC, 20006, US

(21) Appl. No.: 11/415,221

(22) Filed: May 2, 2006

(30) Foreign Application Priority Data
Aug. 30, 2005 (KR) 2005-80363

(51) Int. Cl. B41J 2/435

(52) U.S. Cl. 347/235

(57) ABSTRACT

An apparatus and method to adjust an alignment between scanning lines of a laser printer. The apparatus may include a laser scanning unit having a plurality of laser diodes and an adjustment unit to adjust a plurality of video data using an integer part and a decimal fraction part to synchronize with synchronization signals from the plurality of laser diodes, the integer part and the decimal fraction part constituting a real number that is calculated by using a video clock for synchronizing with the plurality of video data and the synchronization signals from the plurality of laser diodes scanning the plurality of video data. The apparatus and method compensate for an error occurring between the scanning lines due to the location differences of the respective laser diodes.

### CROSS-REFERENCE TO RELATED APPLICATIONS

This application claims priority under 35 U.S.C. § 119 from Korean Patent Application No. 2005-80363, filed Aug. 30, 2005, the entire content of which is incorporated herein by reference.

### BACKGROUND OF THE INVENTION

1. Field of the Invention

The present general inventive concept relates to an apparatus and method to adjust an alignment between scanning lines of a laser printer. More particularly, the present general inventive concept relates to an apparatus and method to adjust an alignment between scanning lines of a laser printer to compensate for a vertical error occurring between scanning lines due to location differences of multi-laser diodes.

2. Description of the Related Art

Laser printers are widely used. With the development of laser printer technology, a laser printer adopting a two-line scanning method has become more popular than a laser printer adopting a single-line scanning method.

The laser printer of the two-line scanning method comprises two laser diodes, but a difference between the locations of the two laser diodes results in an error in a vertical alignment between the two lines.

FIGS. 1A to 1C are timing diagrams to explain a conventional method for adjusting an alignment between scanning lines of a laser printer.

Referring to FIG. 1A, a difference between an input video clock (VCLK) and a synchronization signal (LD1) from a first laser diode is clock-wise counted and the counted number of clocks is set to a first offset.

FIG. 1B illlustrates a first synchronization signal generated by the first laser diode and a second laser diode. The first horizontal synchronization signal (HSYNC) H1 of the first synchronization signal is generated by the synchronization signal LD1 from the first laser diode and a synchronization signal LD2 from the second laser diode. The second HSYNC H2 of the first synchronization signal is generated by the synchronization signal LD1 from the first laser diode. The difference between the first HSYNC H1 and the second HSYNC H2 is clock-wise counted and the counted number of clocks is set to a first count value.

FIG. 1C illustrates a second synchronization signal generated by the first laser diode and the second laser diode. The first HSYNC H1 of the second synchronization signal is generated by the synchronization signal LD1 from the first laser diode and the synchronization signal LD2 from the second laser diode. The second HSYNC H2 of the second synchronization signal is generated by the synchronization signal LD2 from the second laser diode. A difference between the first HSYNC H1 and the second HSYNC H2 is clock-wise counted and the counted number of clocks is set to a second count value.

A difference between the synchronization signal LD1 from the first laser diode and the synchronization signal LD2 from the second laser diode is clock-wise counted by subtracting the second count value from the first count value. The counted number of clocks between the synchronization signals LD1 and LD2 is set to a second offset.

When first video data and second video data are input in synchronization with the VCLK, they are adjusted by using the first offset and the second offset, and thus an alignment error occurring between the two scanning lines is compensated for.

However, since the conventional laser printer uses only two laser diodes, i.e., the first laser diode and the second laser diode, it does not guarantee a high-speed printing operation. Also, an error compensation is possible only when a distance between the synchronization signal LD1 from the first laser diode and the synchronization signal LD2 from the second laser diode falls within a range of 1 dot. In other words, if the difference between the synchronization signals LD1 and LD2 exceeds one period of the VCLK, the error compensation is impossible.

Also, if the first count value is less than the second count value, i.e., if the synchronization signal LD1 from the first laser diode is input later than the synchronization LD2 from the second laser diode, a minus (−) calculation is performed and thus the error compensation is impossible.

### SUMMARY OF THE INVENTION

The present general inventive concept provides an apparatus and method of adjusting an alignment between scanning lines of a laser printer using a plurality of laser diodes.

The present general inventive concept also provides an apparatus and method of adjusting an alignment between scanning lines of a laser printer, which adjusts synchronization signals from laser diodes to compensate for a vertical error occurring between scanning lines due to location differences of the respective laser diodes.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an apparatus to adjust an alignment between scanning lines of a laser printer, including a laser scanning unit having a plurality of laser diodes, and an adjustment unit to adjust a plurality of video data using an integer part and a decimal fraction part to synchronize with synchronization signals from the plurality of laser diodes, the integer part and the decimal fraction part constituting a real number that is calculated by using a video clock to synchronize with the plurality of video data and the synchronization signals from the plurality of laser diodes scanning the plurality of video data.

The adjustment unit may include a counting clock generator to generate a ring clock using an inverter chain, an offset counter to count a number of ring clocks between a synchronization signal from a first laser diode of the plurality of laser diodes and the video clock, based on the ring clock, and to output the counted number of ring clocks as a first offset, a synchronization signal difference calculator to count a number of ring clocks between the synchronization signal from the first laser diode and a synchronization signal from an N-th laser diode, based on the ring clock, and to output the counted number of ring clocks as a second offset, and a video data adjuster to adjust the first video data and the N-th video data in a unit of dot corresponding to the integer part and in a unit of sub-dot corresponding to the decimal fraction part according to the first offset and the second offset.

The video data adjuster may include a first adjuster to adjust the first video data and the N-th video data as much as a number of sub-dots corresponding to the first offset, and a second adjuster to adjust one of the first video data and the N-th video data as much as a sum of dots and sub-dots which corresponds to a sum of the first offset and the second offset.

The second adjuster may include a calculator to calculate a real number by dividing the sum of the first offset and the second offset by a ring counter that is a number of ring clocks constituting one video clock, and separate the real number into an integer part and a decimal fraction part, a dot adjuster to adjust the N-th video data as much as the number of dots corresponding to the integer part, and a sub-dot adjuster to further adjust the N-th video data as much as the number of sub-dots corresponding to the decimal fraction part.

The calculator may divide the decimal fraction part by the ring counter and outputs a factor, and the sub-dot adjuster further adjusts the N-th video data as much as the number of sub-dots by multiplying the variable ring counter by the factor.

The apparatus may further include a memory to store the first offset and the second offset and to update the first offset and the second offset at predetermined time intervals.

The adjustment unit may adjust the first video data and the N-th video data in the unit of dot and in the unit of sub-dot by using the first offset and the second offset stored in the memory.

The apparatus may further include a laser scanning unit controller to further adjust the first video data and the N-th video data that are adjusted and output from the adjustment unit to a firmware data corresponding to a condition of the laser scanning unit, and to control the laser scanning unit.

The laser scanning unit may include a plurality of synchronization signal detecting sensors to detect the synchronization signals generated by laser beams from the plurality of laser diodes.

The foregoing and/or other aspects and utilities of the present general inventive concept may also be achieved by providing a method to adjust an alignment between scanning lines of a laser printer including a laser scanning unit having a plurality of laser diodes, the method including counting a number of ring clocks between a synchronization signal from a first laser diode of the plurality of laser diodes and a video clock, based on a ring clock generated by an inverter chain, and outputting the counted number of ring clocks as a first offset, counting a number of ring clocks between the synchronization signal from the first laser diode and a synchronization signal from an N-th laser diode based on the ring clock, and outputting the counted number of ring clocks as a second offset, and adjusting the first video data and the N-th video data in a unit of dots and in a unit of sub-dots according to the first offset and the second offset.

The adjusting in the unit of dots and in the unit of sub-dots may include adjusting the first video data and the N-th video data as much as a number of sub-dots corresponding to the first offset, and adjusting the N-th video data as much as a sum of dots and sub-dots corresponding to a sum of the first offset and the second offset.

The adjusting the N-th video data as much as the sum of dots and sub-dots corresponding to the sum of the first offset and the second offset may include calculating a real number by dividing the sum of the first offset and the second offset by a ring counter that is a number of ring clocks constituting one video clock, and separating the real number into an integer part and a decimal fraction part, adjusting the N-th video data as much as the number of dots corresponding to the integer part, and further adjusting the N-th video data as much as the number of sub-dots corresponding to the decimal fraction part.

The separating the real number into the integer part and the decimal fraction part may divide the decimal fraction part by the ring counter and may output a factor.

The further adjusting the N-th video data as much as the number of sub-dots corresponding to the decimal fraction part, further adjusts the N-th video data as much as the number of sub-dots by multiplying the ring counter by the factor.

The method may further include storing the first offset and the second offset and updating the first offset and the second offset at predetermined intervals.

The method may further include adjusting the first video data and the N-th video data in the unit of dot and in the unit of sub-dot by using the first stored offset and the second stored offset.

The method may further include adjusting the adjusted and output first video data and N-th video data to a firmware data corresponding to a condition of the laser scanning unit.

The foregoing and/or other aspects and utilities of the present general inventive concept may also be achieved by providing a method to adjust an alignment between scanning lines of a laser printer, the method including aligning a first laser diode among a plurality of laser diodes by using an input video clock as a reference, and compensating for vertical errors in an alignment of the plurality of laser diodes by using the first laser diode as a reference to align each of the other laser diodes of the plurality of diodes.

The foregoing and/or other aspects and utilities of the present general inventive concept may also be achieved by providing a method to adjust an alignment between scanning lines of a laser printer, the method including counting a difference between a synchronization signal output from a first laser diode and an input video clock according to a ring clock generated by a counting clock generator, and calculating differences between the synchronization signal output from the first laser diode and synchronization signals output from each of a plurality of laser diodes.

The method may further include outputting the difference between the synchronization signal output from the first laser diode and the input video clock as a first offset, and outputting one-half of the sum of a first count value and a second count value of the synchronization signal output from the first laser diode and a synchronization signal output from one of the plurality of diodes as a second offset. The method may further include adjusting incoming video data using the first offset and the second offset, and outputting the adjusted video data. The method may further include adjusting incoming first video data according to the first offset, and adjusting incoming second video data according to the first offset and the second offset. The method may further include outputting the first video data as late as the first offset when the synchronization signal from the first laser diode is input later than the input video clock, and outputting the first video data as early as the first offset when the synchronization signal from the first laser diode is input earlier than the input video clock. The method may further include adjusting the incoming second video data using the first offset and the second offset. The method may further include calculating a sum of the first offset and the second offset, outputting a dot offset and a sub-dot offset, adjusting the incoming second video data according to the dot offset, and adjusting the incoming second video data according to the sub-dot offset. The method may further include storing the first offset and the second offset, and updating the memory at predetermined times.

The foregoing and/or other aspects and utilities of the present general inventive concept may also be achieved by providing a method to adjust an alignment between scanning lines of a laser printer, the method including determining whether a plurality of laser beams are emitted from a plurality of laser diodes, counting a first offset value using a synchronization signal from a first laser diode among the plurality of laser diodes and an input video clock, adjusting a first video data of a plurality of video data according to the first offset, counting a second offset value using a synchronization signal from the first laser diode and a synchronization signal from a second laser diode, adjusting a second video data of the plurality of video data according to the first offset and the second offset, determining whether the adjusting of the plurality of video data is completed, and forming scanning lines corresponding to the adjusted video data.

The foregoing and/or other aspects and utilities of the present general inventive concept may also be achieved by providing an apparatus to compensate for vertical errors in an alignment between scanning lines of a laser printer including a photoconductive unit, the apparatus including a laser scanning unit comprising a plurality of laser diodes to emit laser beams, a controller to control the laser diodes to scan the photoconductive unit with the laser beams, and an adjustment unit to adjust the alignment of the scanning lines of the laser printer, the adjustment unit comprising a counting clock generator, an offset counter, a synchronization signal difference calculator, and a video data adjuster.

The clock generator may include an inverter-chain ring oscillator to generate a ring clock having a short period. The offset counter may count a difference between a synchronization signal output from a first laser diode and an input video clock according to a ring clock generated by the counting clock generator, and the synchronization signal difference calculator may calculate differences between the synchronization signal output from the first laser diode and synchronization signals output from each of the other laser diodes of the plurality of diodes. The offset counter may output the difference between the synchronization signal output from the first laser diode and the input video clock as a first offset, and the synchronization signal difference calculator may output one-half of the sum of a first count value and a second count value of the synchronization signal output from the first laser diode and a synchronization signal output from one of the other laser diodes of the plurality of diodes as a second offset. The video data adjuster may adjust incoming video data using the first offset and the second offset and may output the adjusted video data. The video data adjuster may include a first adjuster to adjust incoming first video data according to the first offset, and a second adjuster to adjust incoming second video data according to the second offset. The first adjuster may output the first video data as late as the first offset when the synchronization signal from the first laser diode is input later than the input video clock, and may output the first video data as early as the first offset when the synchronization signal from the first laser diode is input earlier than the input video clock. The second adjuster may adjust the incoming second video data using the first offset and the second offset. The second adjuster may include a second adjuster calculator to calculate a sum of the first offset and the second offset and outputs a dot offset and a sub-dot offset, a dot adjuster to adjust the incoming second video data according to the dot offset, and a sub-dot adjuster to adjust the incoming second video data according to the sub-dot offset. The apparatus may further include a memory to the first offset and the second offset, wherein the adjustment unit updates the memory at predetermined times.

The laser scanning unit may further include a plurality of collimating lenses to transform the emitted laser beams into parallel beams, a cylinder lens to focus the parallel beams onto a polygon mirror, a motor to drive the polygon mirror to reflect the beams transmitted through the cylinder lens by a predetermined angle, an f-theta lens to compensate for an aberration of the beams reflected from the polygon mirror such that the beams are accurately placed on a focal point of a scanning surface, a reflection mirror to reflect the beams passed through the f-theta lens in a predetermined direction such that the beams are incident on an imaging surface of the photoconductive unit, a horizontal synchronization mirror to reflect the beams passed through the f-theta lens in a horizontal direction, and a synchronization signal detecting sensor to receive the beams reflected from the horizontal synchronization mirror and to output synchronization signals to the adjustment unit to compensate for the vertical errors in the alignment between the scanning lines of the laser printer.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIGS. 1A to 1C are timing diagrams illustrating a conventional method for adjusting an alignment between scanning lines of a laser printer;

FIG. 2 is a block diagram illustrating an apparatus to adjust an alignment between scanning lines of a laser printer according to an embodiment of the present general inventive concept;

FIG. 3 is a perspective view illustrating a laser scanning unit according to an embodiment of the present general inventive concept;

FIGS. 4 to 7 are timing diagrams illustrating a method of adjusting an alignment between scanning lines of a laser printer according to an embodiment of the present general inventive concept; and

FIG. 8 is a flowchart illustrating a method of adjusting an alignment between scanning lines of a laser printer according to an embodiment of the present general inventive concept.

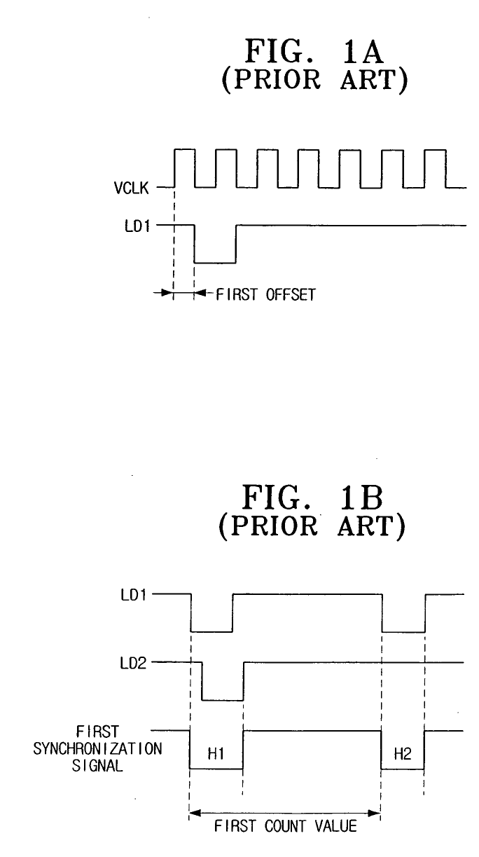

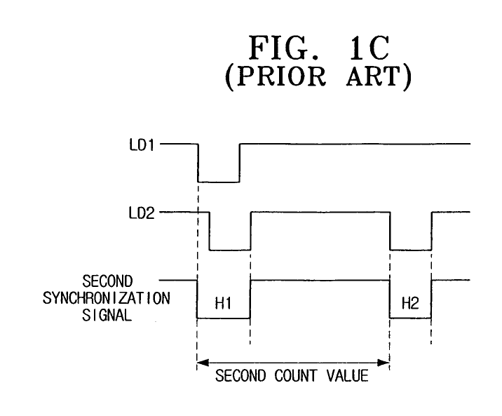

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

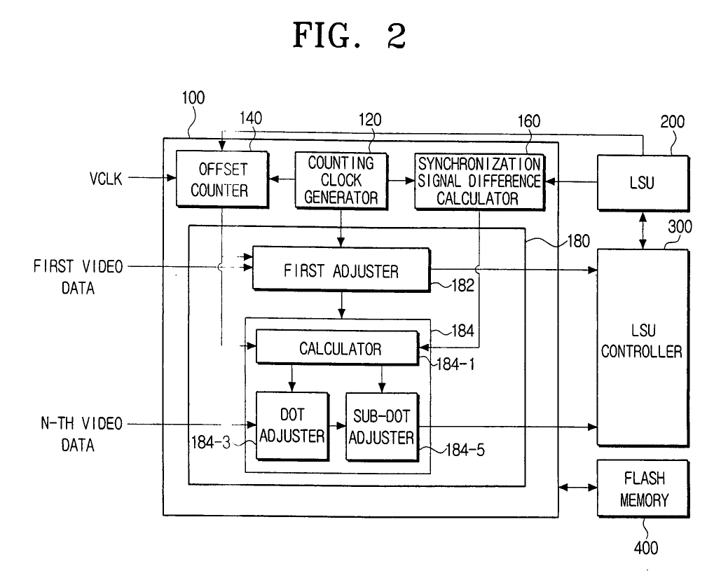

FIG. 2 is a block diagram illustrating an apparatus to adjust an alignment between scanning lines of a laser printer according to an embodiment of the present general inventive concept.

Referring to FIG. 2, the apparatus to adjust the alignment between scanning lines according to the present general inventive concept includes an adjustment unit 100, a laser scanning unit (LSU) 200, a LSU controller 300, and a flash memory 400.

The adjustment unit 100 compensates for a vertical error that occurs between scanning lines due to location differences of laser diodes, and includes a counting clock generator 120, an offset counter 140, a synchronization signal difference calculator 160, and a video data adjuster 180.

The counting clock generator 120 may use an inverter-chain ring oscillator (not illustrated) to generate a ring clock having a short period. The period of the ring clock generated by the counting clock generator 120 depends upon a circuit characteristic, a power supply variation, and a temperature variation of the counting clock generator 120.

The offset counter 140 counts a difference between a synchronization signal from a first laser diode of the LSU 200 and an input video clock (VCLK) according to the ring clock generated by the counting clock generator 120. The counted number of ring clocks is output as a first offset. Subsequently, the first laser diode is used as a reference laser diode so that synchronization signal differences between respective laser diodes and the first laser diode are obtained.

The synchronization signal difference calculator 160 calculates differences between synchronization signals sequentially output from the respective laser diodes of the LSU 200. The synchronization signals are output in the order of the first laser diode, second laser diode, first laser diode, third laser diode, first laser diode, fourth laser diode, and so on.

The number of ring clocks between the synchronization signal from the first laser diode and the synchronization signal from the second laser diode is counted and set to a first count value. The number of ring clocks between the synchronization signal from the second laser diode and the synchronization signal from the first laser diode is counted and set to a second count value. A second offset for the second laser diode is calculated by dividing a difference between the first count value and the second count value by 2. The difference between the first count value and the second count value is calculated by subtracting a smaller one from the larger one.

In the same method as described above, the number of ring clocks between the synchronization signal from the first laser diode and the synchronization signal from the third laser diode is counted and set to a first count value. The number of ring clocks between the synchronization signal from the third laser diode and the synchronization signal from the first laser diode is counted and set to a second count value. A second offset for the third laser diode is calculated by dividing a difference between the first count value and the second count value by 2.

Respective second offsets for the fourth, fifth, . . . , N-th laser diodes are calculated in the same method as described above.

The video data adjuster 180 adjusts incoming video data using the first offset and the second offsets and outputs the adjusted video data so as to compensate for the vertical error that occurs between scanning lines due to location differences of the respective laser diodes. That is, the incoming video data are adjusted to synchronize with the synchronization signals from the respective laser diodes. The video data adjuster 180 includes a first adjuster 182 and a second adjuster 184.

The first adjuster 182 adjusts incoming first video data according to the first offset. For example, if the synchronization signal from the first laser diode is input 60 ring clocks later than the VCLK, the first offset is 60. The first adjuster 182 outputs the first video data as late as 60 ring clocks, thereby compensating for an error that occurs due to the difference between the VCLK and the synchronization signal from the first laser diode.

The second adjuster 184 adjusts the incoming N-th video data according to the first offset and the second offset, and includes a calculator 184-1, a dot adjuster 184-3, and a sub-dot adjuster 184-5.

The calculator 184-1 calculates the sum of the first offset and the second offset and then outputs a dot offset and a sub-dot offset. More specially, if the sum of the first offset and the second offset is divided by the number of ring clocks constituting one VCLK, then a real number is obtained. The real number is separated into an integer part and a decimal fraction part by a decimal point. The integer part is the dot offset and the decimal fractional part is the sub-dot offset.

For example, if the first offset is 60, the second offset is 110, and the number of ring clocks constituting one VLCK is 70, then (60+110)/70=[(2*70)+30]/70=(2*70)/70+30/70. The dot offset is (2*70)/70=2 and the sub-dot offset is 30/70=0.4.

The dot adjuster 184-3 adjusts the incoming N-th video data according to the integer part output from the calculator 184-1. In the above example, the N-th video data is delayed as much as two dots i.e. two video clocks according to the calculated value (2*70)/70=2.

The sub-dot adjuster 184-5 adjusts the N-th video data according to the decimal fraction part output from the calculator 184-1. In the above example, the N-th video data is delayed as much as the calculated 30/70=0.4. If the number of ring clocks constituting one VCKL changes from 70 to 40, for example as a result of a voltage or a temperature change, a sub-dot is adjusted as much as 0.4*40 ring clocks, i.e. 16 ring clocks. 0.4 is a factor that does not change even if the number of ring clocks constituting one VCKL does change.

The LSU 200 may include a plurality of laser diodes (not illustrated) and is controlled by the LSU controller 300 to scan an organic photoconductive drum (not illustrated) with laser beams. A surface of the organic photoconductive drum is charged with a negative (−) electric charge corresponding to the video data such that a printing operation is performed.

The LSU controller 300 controls the laser diodes to scan the organic photoconductive drum with laser beams according to the first, second, . . . , N-th video data output from the adjustment unit 100 after adjustments. Also, the LSU controller 300 performs a dot adjustment according to a pre-set value to satisfy a condition of the laser printer.

The flash memory 400 stores the first offset and the second offset that are counted by the adjustment unit 100 for a predetermined time. That is, the adjustment unit 100 updates the first offset and the second offset periodically and then stores the updated offsets in the flash memory 400. Thus, even when a mechanical change occurs in the laser printer, the adjustment unit 100 updates the first and the second offsets and stores the updated offsets in the flash memory 400.

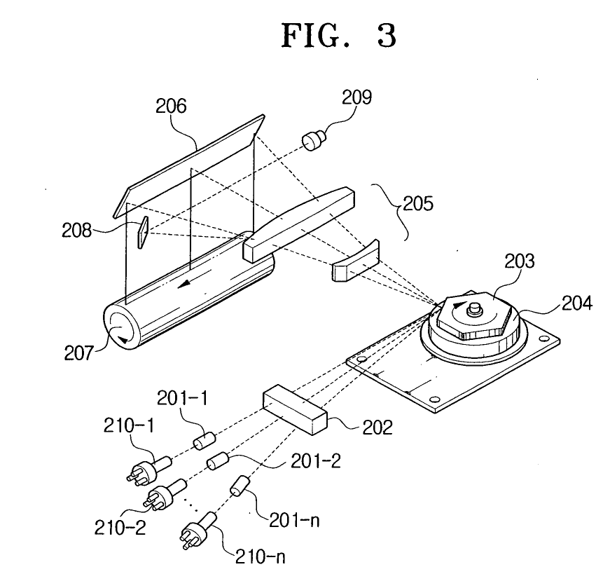

FIG. 3 is a perspective view illustrating the LSU 200 according to an embodiment of the present general inventive concept.

Referring to FIG. 3, the LSU 200 includes first, second, . . . , N-th laser diodes 210-1, 210-2, . . . , 210-n, collimating lens 201-1, 201-2, . . . , 201-n, a cylinder lens 202, a polygon mirror 203, a motor 204, an f-theta (fθ) lens 205, a reflection mirror 206, a horizontal synchronization mirror 208 and a synchronization signal detecting sensor 209.

The first, second, . . . , N-th laser diodes 210-1, 210-2, . . . , 210-n emit laser beams as a light source and are controlled by the LSU controller 300. Under the control of the LSU controller 300, the respective laser diodes scan with laser beams corresponding to the respective video data.

The collimating lenses 201-1, 201-2, . . . , 201-n transform the laser beams emitted from the first, second, . . . , N-th laser diodes 210-1, 210-2, . . . , 210-n into parallel beams. The cylinder lens 202 focuses the parallel beams output from the collimating lenses 201-, 201-2, . . . , 201-n onto the polygon mirror 203. The polygon mirror 203 is driven by the motor 204 and reflects the beams transmitted through the cylinder lens 202 by a predetermined angle.

The f-theta lens 205 has a constant refraction rate with respect to an optical axis, and compensates for an aberration of beams reflected from the polygon mirror 203 such that laser beams are accurately placed on a focal point of a scanning surface. The reflection mirror 206 reflects the beams passing through the f-theta lens 205 in a predetermined direction such that the beams are incident on an imaging surface of an organic photoconductive drum 207.

The horizontal synchronization mirror 208 reflects the beams passing through the f-theta lens 205 toward the synchronization signal detecting sensor 209 in a horizontal direction. The synchronization signal detecting sensor 209 receives the beams reflected from the horizontal synchronization mirror 208, and the synchronization signals output from the synchronization signal detecting sensor 209 are used by the adjustment unit 100 to compensate for the vertical error occurring between the scanning lines.

The synchronization signal detecting sensor 209 detects the beams reflected from the horizontal synchronization mirror 208 and transmits the beams such that the adjustment unit 100 adjusts the video data. Accordingly, a scanning start position of each scanning line is constantly maintained and thus a vertical error is not likely to occur between scanning lines.

Although in this embodiment a single horizontal synchronization mirror 208 and a single synchronization signal detecting sensor 209 are illustrated, the present general inventive concept is not so limited. For example, N-number of synchronization signal detecting sensors may be provided to detect laser beams from the first, second, . . . , N-th laser diodes 210-1, 210-2, . . . , 210-n in sequence.

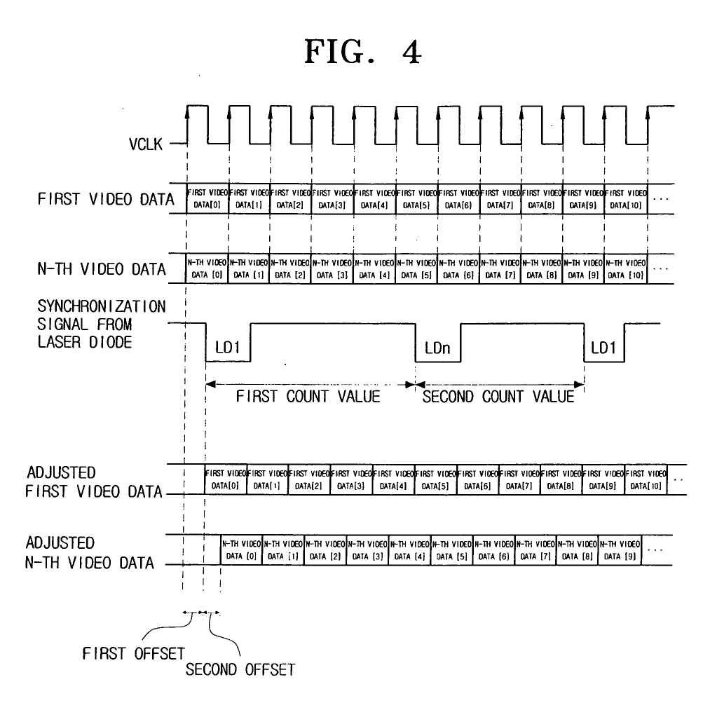

FIGS. 4 to 7 are timing diagrams to illustrate a method of adjusting an alignment between scanning lines of a laser printer according to an embodiment of the present general inventive concept.

FIG. 4 illustrates a first video data and an N-th video data that are adjusted when a VCLK is input earlier than a synchronization signal LD1 from a first laser diode by a first offset and a first count value is greater than a second count value.

In FIG. 4, if the first offset is 60, the first count value is 5120, and the second count value is 4900, then the second offset becomes 110 by a calculation of (5120−4900)/2. In this case, the first video data input in synchronization with the VCLK is delayed as much as the first offset 60. The N-th video data input in synchronization with the VCLK is delayed as much as the sum of the first offset 60 and the second offset 110 (60+110=170).

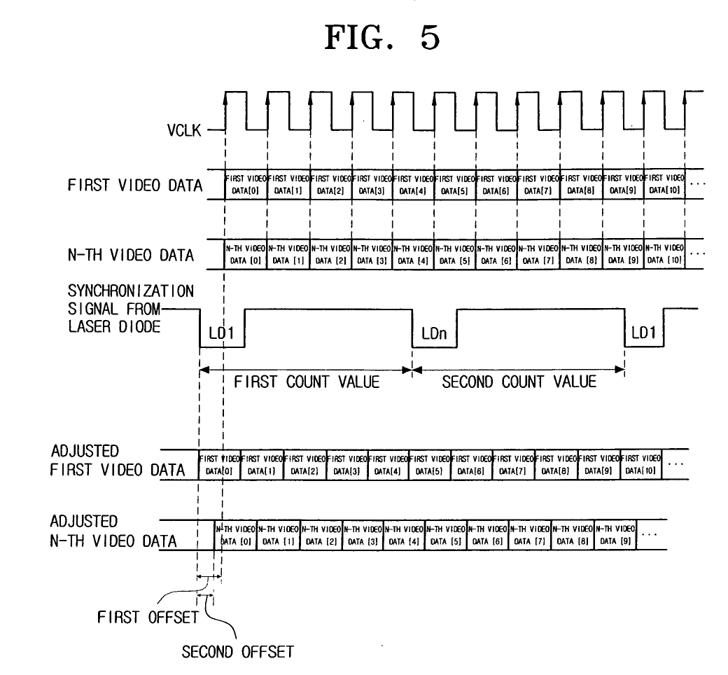

FIG. 5 illustrates the first video data and the N-th video data that are adjusted when the VCLK is input later than the synchronization signal LD1 from the first laser diode by the first offset and the first count value is greater than the second count value.

In FIG. 5, if the first offset is −60, the first count value is 5120, and the second count value is 4900, then the second offset value becomes 110 by a calculation of (5120−4900)/2. In this case, the first video data input in synchronization with the VCLK is input as early as the absolute value of the first offset 60 and the N-th video data input in synchronization with the video clock VCLK is input as early as the difference between the absolute value of the first offset 60 and the second offset 110 (110−60=50).

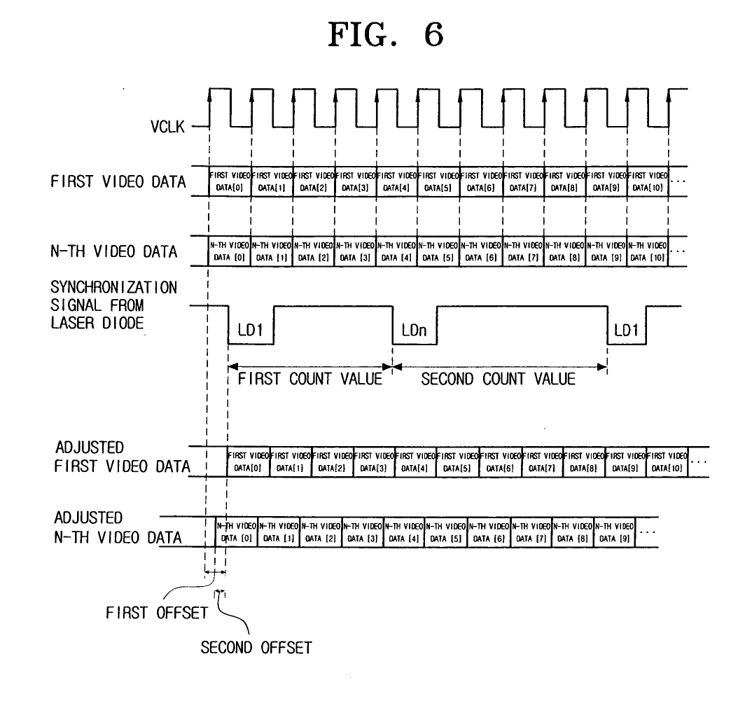

FIG. 6 illustrates the first video data and the N-th video data that are adjusted when the VCLK is input earlier than the synchronization signal LD1 from the first laser diode by the first offset and the first count value is less than the second count value.

In FIG. 6, if the first offset is 60, the first count value is 4900, and the second count value is 5120, then the second offset becomes 110 by a calculation of (5120−4900)/2. In this case, the first video data input in synchronization with the VCLK is delayed as much as the first offset value 60, and the N-th video data input in synchronization with the VCLK is delayed as much as the difference between the first offset 60 and the second offset 110 (110−60=50).

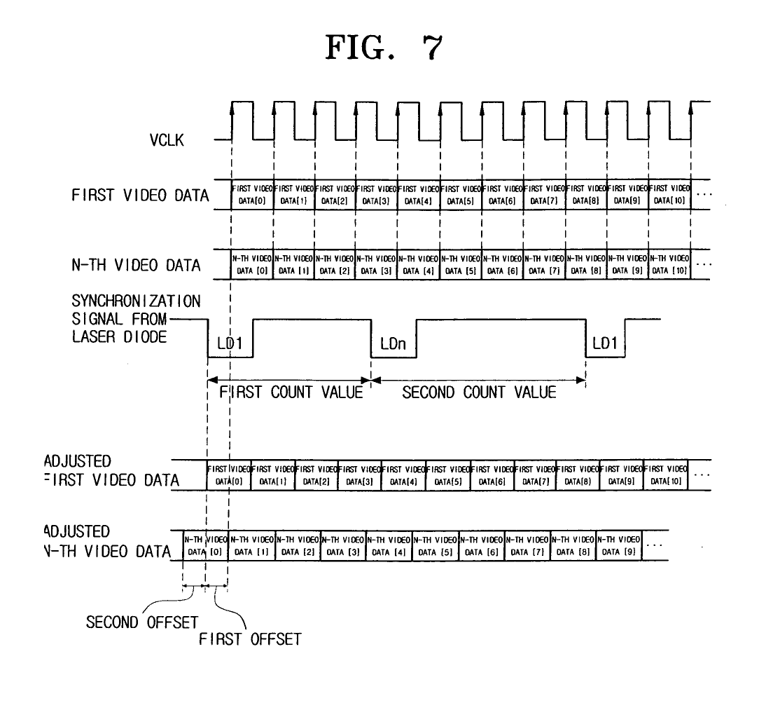

FIG. 7 illustrates the first video data and the N-th video data that are adjusted when the VCLK is input later than the synchronization signal LD1 from the first laser diode by the first offset and the first count value is less than the second count value.

In FIG. 7, if the first offset is −60, the first count value is 4900, and the second count value is 5120, then the second offset becomes 110 by a calculation of (5120−4900)/2. In this case, the first video data input in synchronization with the VCLK is input as early as the absolute value of the first offset 60, and the N-th video data input in synchronization with the VCLK is input as early as the sum of the absolute value of the first offset 60 and the second offset 110 (60+110=170).

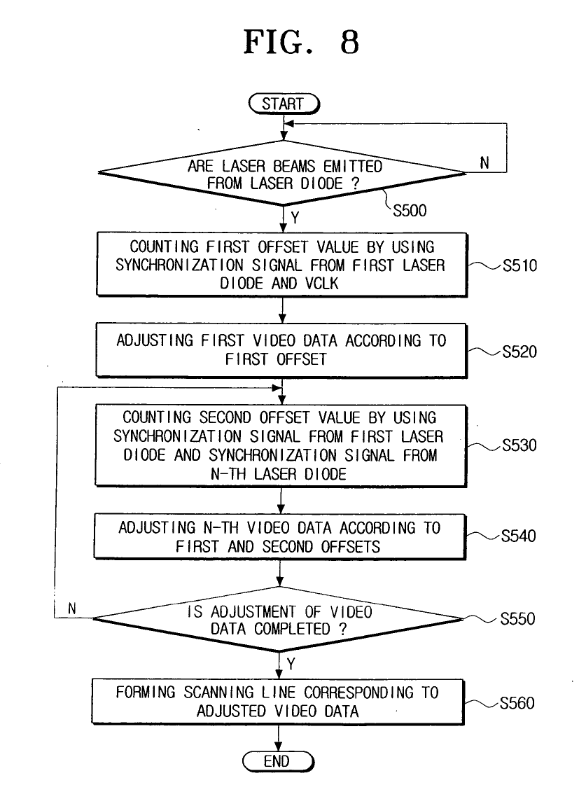

FIG. 8 is a flowchart illustrating a method of adjusting an alignment between scanning lines of a laser printer according to an embodiment of the present general inventive concept.

Referring to FIG. 8, it is determined whether laser beams are emitted from the first, second, . . . , N-th laser diodes at operation S500. More specifically, if the laser beams are emitted from the first, second, . . . , N-th laser diodes 210-1, 210-2, . . . , 210-n under the control of the LSU controller 300 (see FIG. 2), synchronization signals from the first, second, . . . , the N-th laser diodes 210-1, 210-2, . . . , 210-n are detected in the order of first, second, first, third, first, fourth, first, and so on.

A first offset is counted by using the synchronization signal from the first laser diode 210-1 and the VCLK at operation S510. More specifically, the number of ring clocks between the synchronization signal from the first laser diode 210-1 and the VCLK is counted and set to the first offset.

First video data is adjusted according to the first offset at operation S520. That is, if the synchronization signal from the first laser diode 210-1 is input later than the VCLK as illustrated in FIGS. 4 to 7, the first video data is adjusted to be delayed as much as the first offset. On the other hand, if the synchronization signal from the first laser diode 210-1 is input earlier than the VCLK, the first video data is adjusted to be input as early as the first offset.

Next, a second offset is calculated by using the synchronization signal from the first laser diode 210-1 and the synchronization signal from the N-th laser diode 210-n at operation S530. More specifically, the number of ring clocks between the synchronization signal from the first laser diode 210-1 and the synchronization signal from the N-th laser diode 210-n is set to a first count value and the number of ring clocks between the synchronization signal from the N-th laser diode 210-n and the synchronization signal from the first laser diode 210-1 is set to a second count value. A difference between the first count value and the second count value is set to the second offset.

The N-th video data is adjusted according to the first offset and the second offset at operation S540. More specifically, if the first count value is greater than the second count value, the N-th video data is adjusted to be input the second offset later than the first video data that is adjusted as much as the first offset. On the other hand, if the first count value is less than the second count value, the N-th video data is adjusted to be input the second offset earlier than the first video data that is adjusted as much as the first offset.

By dividing the sum of the first offset and the second offset by the number of ring clocks constituting one VCLK, the second video data is a real number. The real number is separated to an integer part and a decimal fraction part by a decimal point. The second adjuster 184 performs a dot adjustment corresponding to the integer part and a sub-dot adjustment corresponding to the decimal fraction part at operation S540.

If the adjustments of the first, second, . . . , N-th video data are completed at operation S550, the LSU controller 300 controls the LSU 200 (see FIG. 2) to form scanning lines corresponding to the adjusted video data at operation S560.

If the adjustments of the video data are not completed, the operations S530 and S540 are repeated to thereby complete the adjustments of the video data. The first offset and the second offset obtained at the operations S510 and S530 are periodically updated and stored in the flash memory 400 (see FIG. 2). The adjustment unit 100 adjusts the video data with reference to the first offset and the second offset stored in the flash memory 400 (see FIG. 2).

As described above, since the video data are adjusted, it is possible to compensate for an error occurring between the scanning lines due to the location differences of a plurality of laser diodes.

According to the present general inventive concept, since the laser printer uses a plurality of laser diodes, it can achieve a high-speed printing operation. Also, the laser printer adjusts values resulting from circuit characteristic, voltage variation, and temperature variation, and thus reduces a vertical error occurring between the scanning lines due to the misalignment of the laser diodes.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to adjust an alignment between scanning lines of a laser printer, comprising:
a laser scanning unit having a plurality of laser diodes; and
an adjustment unit to adjust a plurality of video data using an integer part and a decimal fraction part to synchronize with synchronization signals from the plurality of laser diodes, the integer part and the decimal fraction part constituting a real number that is calculated by using a video clock to synchronize with the plurality of video data and the synchronization signals from the plurality of laser diodes scanning the plurality of video data.

2. The apparatus as claimed in claim 1, wherein the adjustment unit comprises:
a counting clock generator to generate a ring clock using an inverter chain;
an offset counter to count a number of ring clocks between a synchronization signal from a first laser diode of the plurality of laser diodes and the video clock, based on the ring clock, and to output the counted number of ring clocks as a first offset;
a synchronization signal difference calculator to count a number of ring clocks between the synchronization signal from the first laser diode and a synchronization signal from an N-th laser diode, based on the ring clock, and to output the counted number of ring clocks as a second offset; and
a video data adjuster to adjust the first video data and the N-th video data in a unit of dot corresponding to the integer part and in a unit of sub-dot corresponding to the decimal fraction part according to the first offset and the second offset.

3. The apparatus as claimed in claim 2, wherein the video data adjuster comprises:
a first adjuster to adjust the first video data and the N-th video data as much as a number of sub-dots corresponding to the first offset; and
a second adjuster to adjust one of the first video data and the N-th video data as much as a sum of dots and sub-dots which corresponds to a sum of the first offset and the second offset.

4. The apparatus as claimed in claim 3, wherein the second adjuster comprises:
a calculator to calculate a real number by dividing the sum of the first offset and the second offset by a ring counter that is a number of ring clocks constituting one video clock, and separate the real number into an integer part and a decimal fraction part;
a dot adjuster to adjust the N-th video data as much as the number of dots corresponding to the integer part; and
a sub-dot adjuster to further adjust the N-th video data as much as the number of sub-dots corresponding to the decimal fraction part.

5. The apparatus as claimed in claim 4, wherein the calculator divides the decimal fraction part by the ring counter and outputs a factor, and
the sub-dot adjuster further adjusts the N-th video data as much as the number of sub-dots by multiplying the variable ring counter by the factor.

6. The apparatus as claimed in claim 1, further comprising a memory to store the first offset and the second offset and to update the first offset and the second offset at predetermined time intervals.

7. The apparatus as claimed in claim 6, wherein the adjustment unit adjusts the first video data and the N-th video data in the unit of dot and in the unit of sub-dot by using the first offset and the second offset stored in the memory.

8. The apparatus as claimed in claim 1, further comprising a laser scanning unit controller to further adjust the first video data and the N-th video data that are adjusted and output from the adjustment unit to a firmware data corresponding to a condition of the laser scanning unit, and to control the laser scanning unit.

9. The apparatus as claimed in claim 1, wherein the laser scanning unit comprises a plurality of synchronization signal detecting sensors to detect the synchronization signals generated by laser beams from the plurality of laser diodes.

10. A method to adjust an alignment between scanning lines of a laser printer including a laser scanning unit having a plurality of laser diodes, the method comprising:
counting a number of ring clocks between a synchronization signal from a first laser diode of the plurality of laser diodes and a video clock, based on a ring clock generated by an inverter chain, and outputting the counted number of ring clocks as a first offset;
counting a number of ring clocks between the synchronization signal from the first laser diode and a synchronization signal from an N-th laser diode based on the ring clock, and outputting the counted number of ring clocks as a second offset; and
adjusting the first video data and the N-th video data in a unit of dots and in a unit of sub-dots according to the first offset and the second offset.

11. The method as claimed in claim 10, wherein the adjusting in the unit of dots and in the unit of sub-dots comprises:
adjusting the first video data and the N-th video data as much as a number of sub-dots corresponding to the first offset; and
adjusting the N-th video data as much as a sum of dots and sub-dots corresponding to a sum of the first offset and the second offset.

12. The method as claimed in claim 11, wherein the adjusting the N-th video data as much as the sum of dots and sub-dots corresponding to the sum of the first offset and the second offset comprises:
calculating a real number by dividing the sum of the first offset and the second offset by a ring counter that is a number of ring clocks constituting one video clock, and separating the real number into an integer part and a decimal fraction part;
adjusting the N-th video data as much as the number of dots corresponding to the integer part; and
further adjusting the N-th video data as much as the number of sub-dots corresponding to the decimal fraction part.

13. The method as claimed in claim 12, wherein the separating the real number into the integer part and the decimal fraction part divides the decimal fraction part by the ring counter and outputs a factor.

14. The method as claimed in claim 13, wherein the further adjusting the N-th video data as much as the number of sub-dots corresponding to the decimal fraction part further adjusts the N-th video data as much as the number of sub-dots by multiplying the ring counter by the factor.

15. The method as claimed in claim 10, further comprising storing the first offset and the second offset and updating the first offset and the second offset at predetermined time intervals.

16. The method as claimed in claim 15, further comprising adjusting the first video data and the N-th video data in the unit of dot and in the unit of sub-dot by using the stored first offset and the stored second offset.

17. The method as claimed in claim 10, further comprising adjusting the adjusted and output first video data and N-th video data to a firmware data corresponding to a condition of the laser scanning unit.

18. A method to adjust an alignment between scanning lines of a laser printer, the method comprising:
aligning a first laser diode among a plurality of laser diodes by using an input video clock as a reference; and
compensating for vertical errors in an alignment of the plurality of laser diodes by using the first laser diode as a reference to align each of the other laser diodes of the plurality of diodes.

19. A method to adjust an alignment between scanning lines of a laser printer, the method comprising:
counting a difference between a synchronization signal output from a first laser diode and an input video clock according to a ring clock generated by a counting clock generator; and
calculating differences between the synchronization signal output from the first laser diode and synchronization signals output from each of a plurality of laser diodes.

20. The method of claim 19, further comprising:
outputting the difference between the synchronization signal output from the first laser diode and the input video clock as a first offset; and
outputting one-half of the sum of a first count value and a second count value of the synchronization signal output from the first laser diode and a synchronization signal output from one of the plurality of diodes as a second offset.

21. The method of claim 20, further comprising:
adjusting incoming video data using the first offset and the second offset; and
outputting the adjusted video data.

22. The method of claim 20, further comprising:
adjusting incoming first video data according to the first offset; and
adjusting incoming second video data according to the first offset and the second offset.

23. The method of claim 22, further comprising:
outputting the first video data as late as the first offset when the synchronization signal from the first laser diode is input later than the input video clock; and
outputting the first video data as early as the first offset when the synchronization signal from the first laser diode is input earlier than the input video clock.

24. The method of claim 22, further comprising adjusting the incoming second video data using the first offset and the second offset.

25. The method of claim 24, further comprising:
calculating a sum of the first offset and the second offset;
outputting a dot offset and a sub-dot offset;
adjusting the incoming second video data according to the dot offset; and
adjusting the incoming second video data according to the sub-dot offset.

26. The method of claim 20, further comprising:
storing the first offset and the second offset; and
updating the memory at predetermined times.

27. A method to adjust an alignment between scanning lines of a laser printer, the method comprising:
determining whether a plurality of laser beams are emitted from a plurality of laser diodes;
counting a first offset value using a synchronization signal from a first laser diode among the plurality of laser diodes and an input video clock;
adjusting a first video data of a plurality of video data according to the first offset;
counting a second offset value using a synchronization signal from the first laser diode and a synchronization signal from a second laser diode;
adjusting a second video data of the plurality of video data according to the first offset and the second offset;
determining whether the adjusting of the plurality of video data is completed; and
forming scanning lines corresponding to the adjusted video data.

28. An apparatus to compensate for vertical errors in an alignment between scanning lines of a laser printer including a photoconductive unit, the apparatus comprising:
a laser scanning unit comprising a plurality of laser diodes to emit laser beams;
a controller to control the laser diodes to scan the photoconductive unit with the laser beams; and
an adjustment unit to adjust the alignment of the scanning lines of the laser printer, the adjustment unit comprising a counting clock generator, an offset counter, a synchronization signal difference calculator, and a video data adjuster.

29. The apparatus of claim 28, wherein the clock generator comprises an inverter-chain ring oscillator to generate a ring clock having a short period.

30. The apparatus of claim 28, wherein:
the offset counter counts a difference between a synchronization signal output from a first laser diode and an input video clock according to a ring clock generated by the counting clock generator; and
the synchronization signal difference calculator calculates differences between the synchronization signal output from the first laser diode and synchronization signals output from each of the other laser diodes of the plurality of diodes.

31. The apparatus of claim 30, wherein:
the offset counter outputs the difference between the synchronization signal output from the first laser diode and the input video clock as a first offset; and
the synchronization signal difference calculator outputs one-half of the sum of a first count value and a second count value of the synchronization signal output from the first laser diode and a synchronization signal output from one of the other laser diodes of the plurality of diodes as a second offset.

32. The apparatus of claim 31, wherein the video data adjuster adjusts incoming video data using the first offset and the second offset and outputs the adjusted video data.

33. The apparatus of claim 32, wherein the video data adjuster comprises:
a first adjuster to adjust incoming first video data according to the first offset; and
a second adjuster to adjust incoming second video data according to the second offset.

34. The apparatus of claim 33, wherein the first adjuster outputs the first video data as late as the first offset when the synchronization signal from the first laser diode is input later than the input video clock, and outputs the first video data as early as the first offset when the synchronization signal from the first laser diode is input earlier than the input video clock.

35. The apparatus of claim 33, wherein the second adjuster adjusts the incoming second video data using the first offset and the second offset.

36. The apparatus of claim 35, wherein the second adjuster comprises:
a second adjuster calculator to calculate a sum of the first offset and the second offset and outputs a dot offset and a sub-dot offset;
a dot adjuster to adjust the incoming second video data according to the dot offset; and
a sub-dot adjuster to adjust the incoming second video data according to the sub-dot offset.

37. The apparatus of claim 31, further comprising a memory to the first offset and the second offset, wherein the adjustment unit updates the memory at predetermined times.

38. The apparatus of claim 28, wherein the laser scanning unit further comprises:
a plurality of collimating lenses to transform the emitted laser beams into parallel beams;
a cylinder lens to focus the parallel beams onto a polygon mirror;
a motor to drive the polygon mirror to reflect the beams transmitted through the cylinder lens by a predetermined angle;
an f-theta lens to compensate for an aberration of the beams reflected from the polygon mirror such that the beams are accurately placed on a focal point of a scanning surface;
a reflection mirror to reflect the beams passed through the f-theta lens in a predetermined direction such that the beams are incident on an imaging surface of the photoconductive unit;
a horizontal synchronization mirror to reflect the beams passed through the f-theta lens in a horizontal direction; and
a synchronization signal detecting sensor to receive the beams reflected from the horizontal synchronization mirror and to output synchronization signals to the adjustment unit to compensate for the vertical errors in the alignment between the scanning lines of the laser printer.
